(19) United States
(12) Patent Application Publication
(10) Pub. No.: US 2008/0076019 A1
(43) Pub. Date: Mar. 27, 2008

(54) Core Structure for a Square Lithium Secondary Battery

(76) Inventor: Donald P. H. WU, Hsin-Feng Hsiang (TW)

Correspondence Address: Dr. BANGER SHIA, 102 Lindencrest Ct., Sugar Land, TX, 77479-5201, US

(21) Appl. No.: 11/534,269

(22) Filed: Sep. 22, 2006

(51) Int. Cl. H01M 2/26

(52) U.S. Cl. 429/161; 429/94

(57) ABSTRACT

A core structure for a square lithium secondary battery comprises: a core, an electrode assembly, and two conductive fixing assemblies. The respective layers of the positive and negative lead areas are clamped together by the conductive pressing pieces, therefore, the structure of the present invention is simple. In addition, the respective layers of the positive and negative lead areas are pressed against and in electrical contact with one another directly. Therefore, the internal resistance of the present invention is relative low, and is suitable for use in the high capacity battery case.

### BACKGROUND OF THE INVENTION

1. Field of the Invention

The present invention relates to a core structure for a square lithium secondary battery, and more particularly to the design of a conductive connecting structure for a core of a lithium secondary battery.

2. Description of the Prior Art

Most of square lithium secondary batteries are of low capacity and are rechargeable. For example, U.S. Pat. No. 6,844,109 discloses a commonly used low capacity type square lithium secondary battery, as shown in FIG. 1, wherein the core assembly 10 essentially comprises: an electrode assembly 11, a plurality of positive and negative leads 121, 122, and two conductive sleeves 13. The electrode assembly 11 generally includes a positive layer, a separating layer, and a negative layer that are superposed on one another. The electrode is a multi-layer structure formed by superposing or winding method, and a plurality of positive and negative leads extends form the respective positive and negative layers; then, two conductive pressing pieces are used as an integral lead for the respective positive or negative leads.

The abovementioned secondary lithium battery is very simple in structure, but its structure is also too weak; therefore, it is suitable only for a structure of a low capacity battery, and not for high capacity dynamic battery. As shown in FIGS. 2 and 3, an electrode assembly 20 for a square battery disclosed in TW Pat. No. 1,233,227 comprises a positive layer, a separating layer, and a negative layer that are superposed one another. The electrode assembly 20 is a whorled multi-layer structure winding around a base board21. An uncoated area 22 is formed at a side of each of the positive and negative layers, a plurality of main spacers 23 and sub-spacers 24 are disposed on the uncoated areas 22 of the respective layers of the electrode assembly 20, and then a plurality of fixing pins 25 is inserted through the main spacers 23, the sub-spacers 24 and the base board21, thus forming an integrated electrical connection structure of the electrode assembly.

It is to be noted that the base board improves the structural strength of the battery structure. In addition, the multiple positive or negative layers can be firmly wound around the base plate. Therefore, this design is suitable for use in a high capacity battery.

The conventional lead can be replaced by connecting the main spacers and the sub-spacers directly to the respective layers of the electrode assembly, saving the process for welding or forming the leads. Nevertheless, a disadvantage associated with this kind of conventional battery structures is that each of the layers of the electrode assembly must be equipped with a main spacer and a sub-spacer. If the number of the layers is large, the number of the main spacers and the sub-spacers will also increase accordingly, resulting in an increase of the production cost and complication of the assembling process. And more importantly, the main spacers disposed in the respective layers of the electrode assembly increase the internal resistance (contact resistance) of the core structure of the battery, resulting in temperature increase and energy waste. And in the charge and discharge process of a high capacity battery, high contact resistance may also result in a rise in temperature associated with oxidation of the uncoated area of the electrode assembly

The present invention has arisen to mitigate and/or obviate the afore-described disadvantages.

### SUMMARY OF THE INVENTION

The primary objective of the present invention is to provide a core structure for a square lithium secondary battery. The respective layers of the positive and negative lead areas are clamped together by conductive pressing pieces. Therefore, the structure of the present invention is simple. In addition, the respective layers of the positive and negative lead areas are pressed against and in electrical contact with each other directly, When compared with the conventional structure, the internal resistance of the present invention is relatively low, and is suitable for a battery of high capacity.

The secondary objective of the present invention is to provide a core structure for a square lithium secondary battery. The respective layers of the positive and negative lead areas are clamped together by conductive pressing pieces. Since the structure of the present invention is simple, the manufacture cost and the complexity of the assembling process will be reduced substantially.

### BRIEF DESCRIPTION OF THE DRAWINGS

FIG. 1 is an illustrative view of a conventional core structure for a lithium secondary battery disclosed in U.S. Pat. No. 6,844,109;

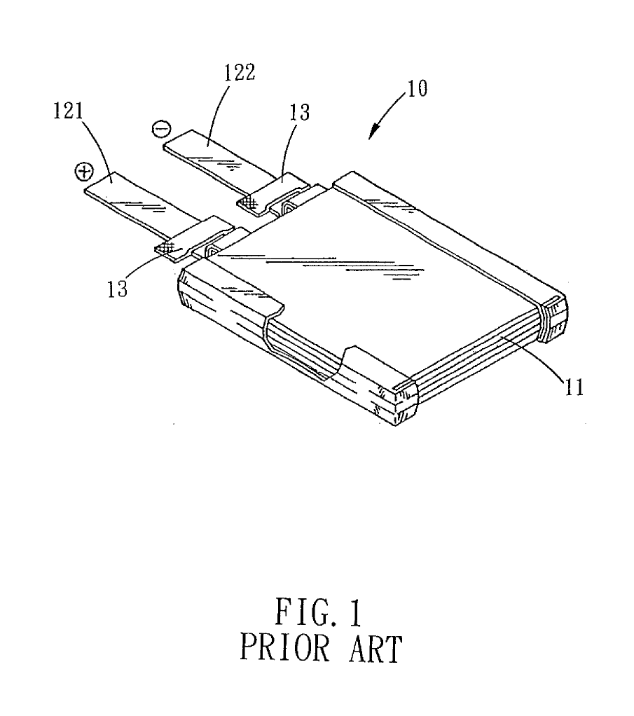

FIG. 2 is an exploded view of a conventional core structure for a lithium secondary battery disclosed in TW Pat. No. 1,233,227;

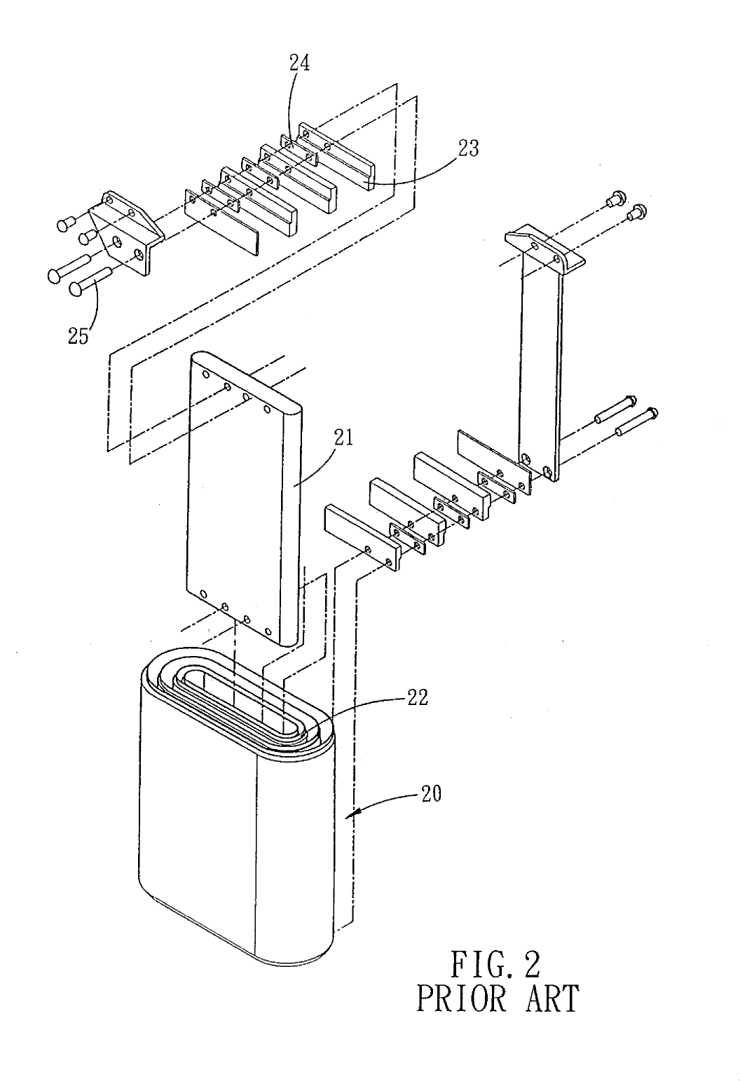

FIG. 3 is an assembly view of a conventional core structure for a lithium secondary battery disclosed in TW Pt No 1233227;

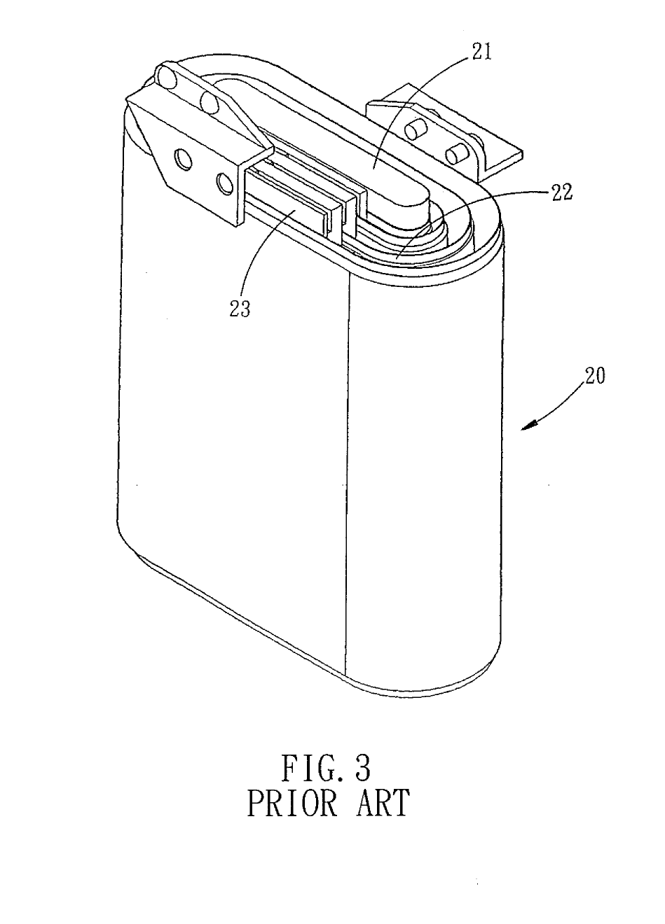

FIG. 4 is a perspective view of showing a core structure for a lithium secondary battery in accordance with the present invention;

FIG. 5 is an assembly view of showing the core structure for a lithium secondary battery in accordance with the present invention;

FIG. 6 is a cross sectional view of showing the core structure for a lithium secondary battery in accordance with the present invention;

FIG. 7 is an exploded view in accordance with the present invention of showing the core structure for a lithium secondary battery before being installed in the battery case;

FIG. 8 is a cross sectional view in accordance with the present invention of showing the core structure for a lithium secondary battery after being installed in the battery case; and

FIG. 9 is a cross sectional view in accordance with the present invention of showing the interior of the battery case, wherein the core structure is additionally provided with conductive sleeves.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

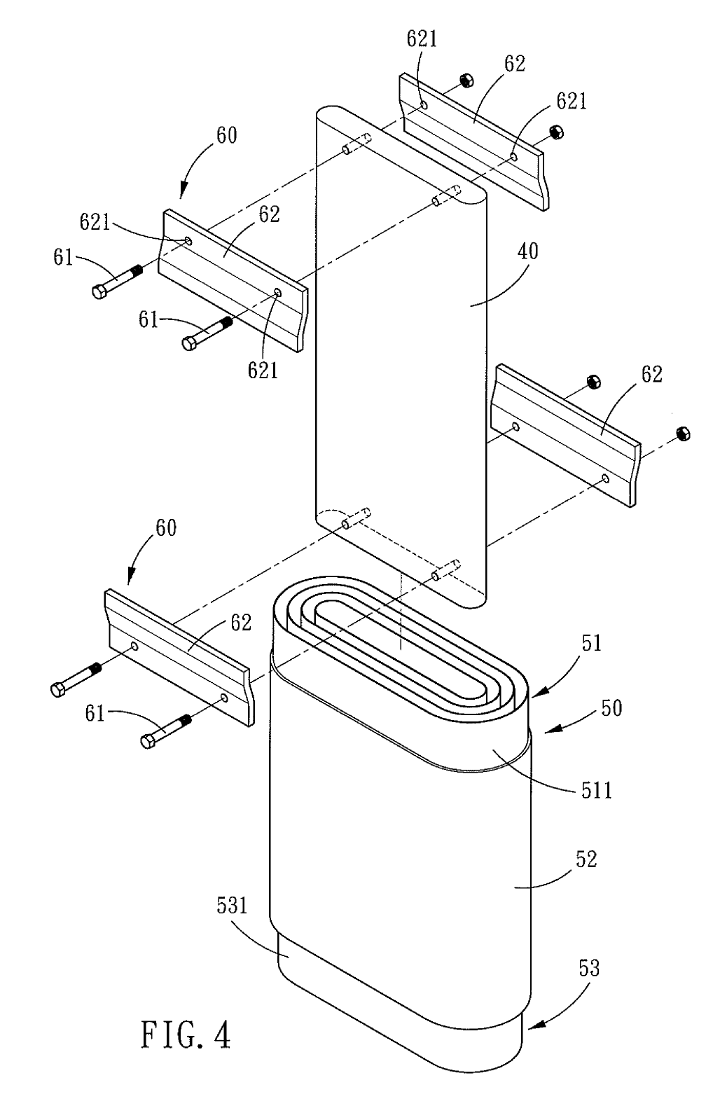

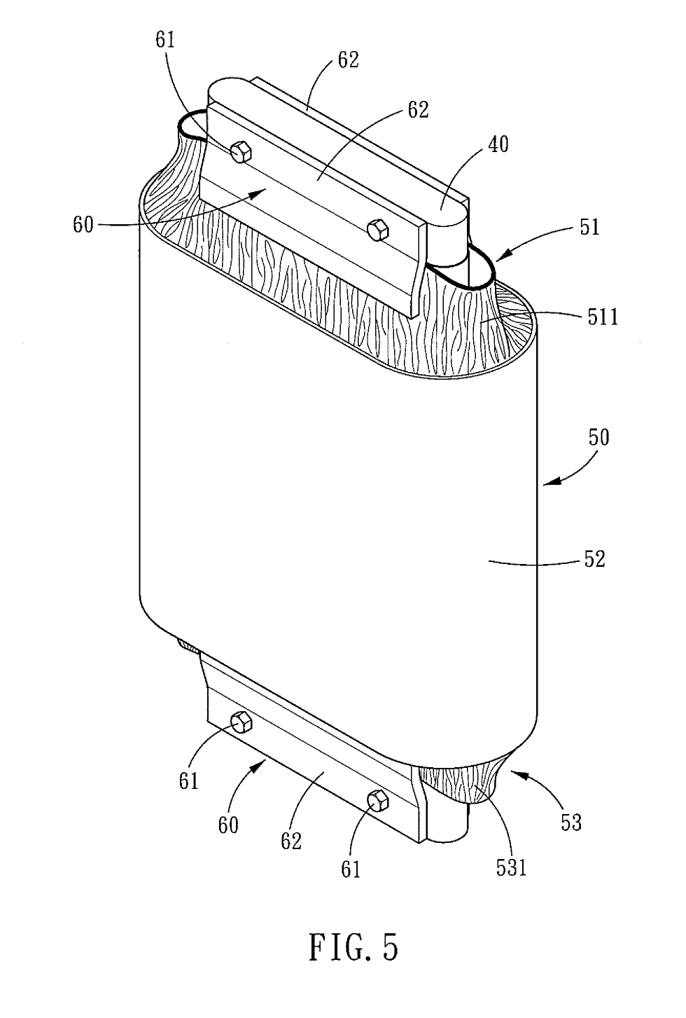

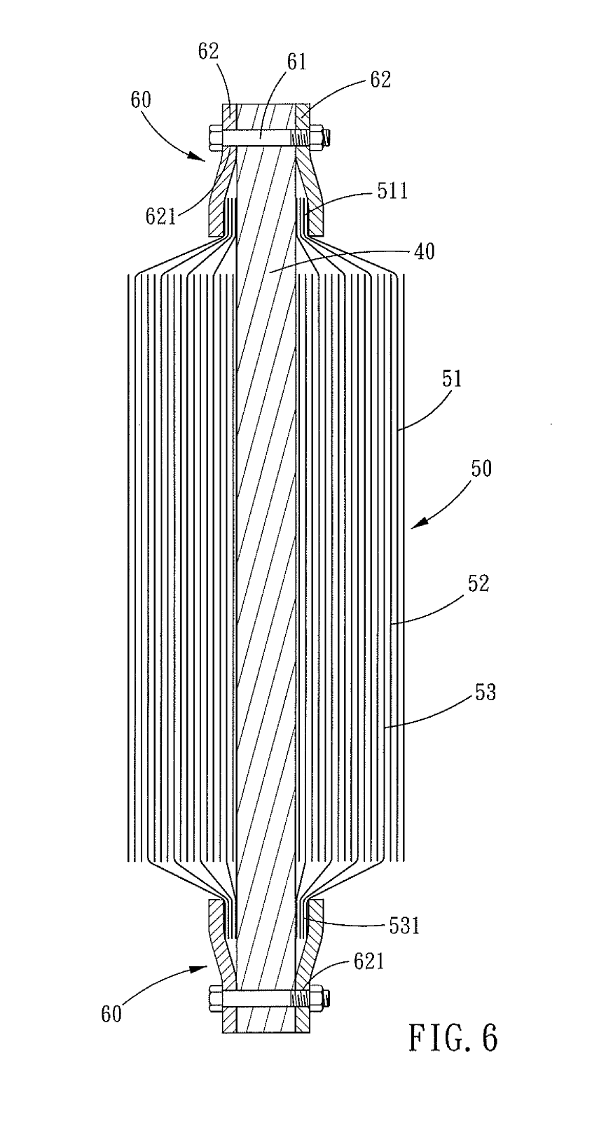

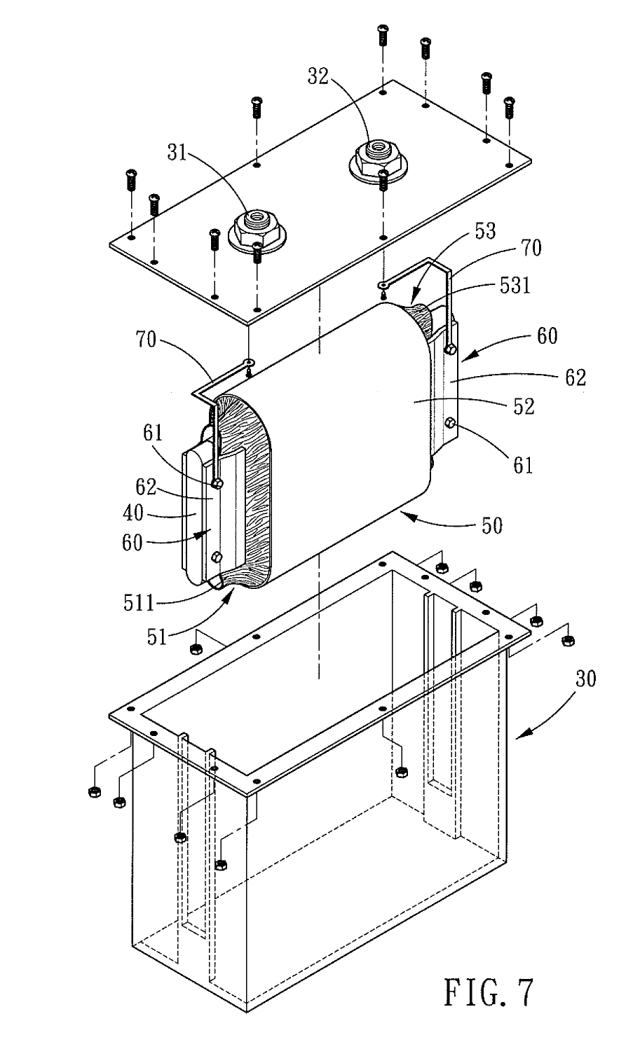

Referring to FIGS. 4-7, a core structure for a square lithium secondary battery in accordance with a preferred embodiment of the present invention comprises: a base board 40, an electrode assembly 50, and two conductive fixing assemblies 60. The core structure is disposed in a square battery case 30, and the positive and negative lead terminals 31, 32 on both ends of the battery case 30 are electrically connected by two connecting members 70.

The base board 40 is disposed in the battery case 30.

The electrode assembly 50 includes at least one positive layer 51, one separating layer 52 and one negative layer 53 that are superposed one another and then wind around the base board 40. The surfaces of the positive and negative electrode layers 51, 53 are coated with positive electrode material and negative electrode material, respectively. The separating layer 52 is located between the positive and negative electrode layers 51, 53. An uncoated area is formed at a side of the positive layer 51 for use as a positive lead area 511, and the negative layer 52 is formed at another side thereof opposite the positive layer 51 with an uncoated area for use as a negative lead area 531. The positive and negative lead areas 511 and 531 protrude out of both sides of the assembly of positive layer 51, the separating layer 52 and the negative layer 53. After the electrode assembly 50 is formed by winding the positive layer 51, the separating layer 52 and the negative layer 53 around the base board 40, the positive and negative lead areas 511 and 531 will protrude out of both ends of the electrode assembly 50.

Each of the conductive fixing assemblies 60 includes a fastener 61 and two conductive pressing pieces 62. The conductive pressing pieces 62 each is formed with a through hole 621 and is disposed outside the positive lead area 511 or the negative lead area 531. The fastener can be a bolt and is inserted through the through hole 621 of one of the conductive pressing pieces 62, the base board 40, and the through hole 621 of another one of the conductive pressing pieces 62, so that the two conductive pressing pieces 62 are fixed on the base board 40 and are firmly pressed against the positive lead area 511 or the negative lead area 531, and the positive lead area 511 or the negative lead area 531 are maintained in a close electrical contact with the conductive pressing pieces 62.

Each of the connecting members 70 is a conductive and curved flexible structure having one end electrically connected to the conductive pressing pieces 62 of the electrode assembly 50 and another end electrically connected to the positive lead terminal 31 or the negative lead terminal 32.

The core structure and the arrangement relation of the components thereof are mentioned above. The present invention intends to further improve the design of the core structure and to use the connecting member as an electrical conductive connection for connecting the conductive pressing pieces to the positive lead area or the negative lead area, and the connecting member is a curved flexible structure. By such arrangements, even if there is a dimension error in the core or the case, which can be overcome by the deformation of the connecting member, and thus the battery can be assembled successfully.

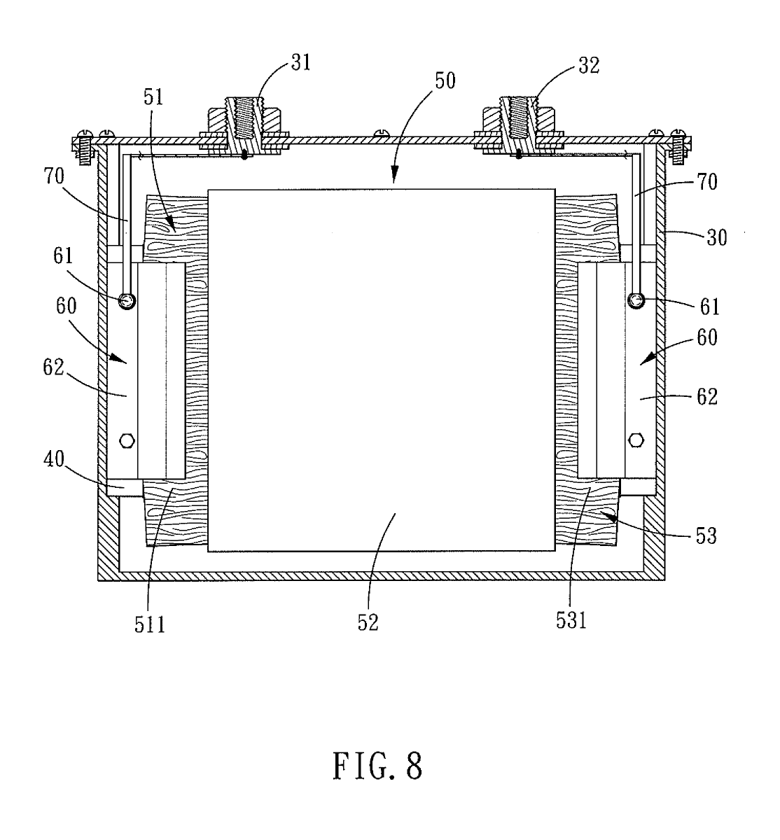

Referring to FIGS. 4-8 again, the large uncoated lead areas 511 and 531 are left on the electrode assembly 50, and the positive and negative lead areas 511, 531 are multi-layer structure. The conductive pressing pieces 62 of the conductive fixing assemblies 60 are fixed outside of the positive and negative lead areas 511, 531, and the fastener 61 passes through the through hole 621 of the conductive pressing piece 62 and the base board 40 and is fixed thereto, so that a part of the conductive pressing pieces 62 is firmly pressed against the respective layers of the positive and negative lead areas 511, 531. In this way, electric energy of the electrode assembly 50 can be outputted smoothly from the conductive pressing pieces 62 via the positive and negative lead areas 511, 531.

It is to be noted that the respective layers of the positive and negative lead areas 511, 531 are clamped together by the conductive pressing pieces 62, therefore, the structure of the present invention is simple. In addition, the respective layers of the positive and negative lead areas 511, 531 are pressed against and in electrical contact with one another directly. Therefore, as compared with the conventional structure made of the main and sub-spacers, the internal resistance of the present invention is obviously low, and is suitable for use in the high capacity battery case.

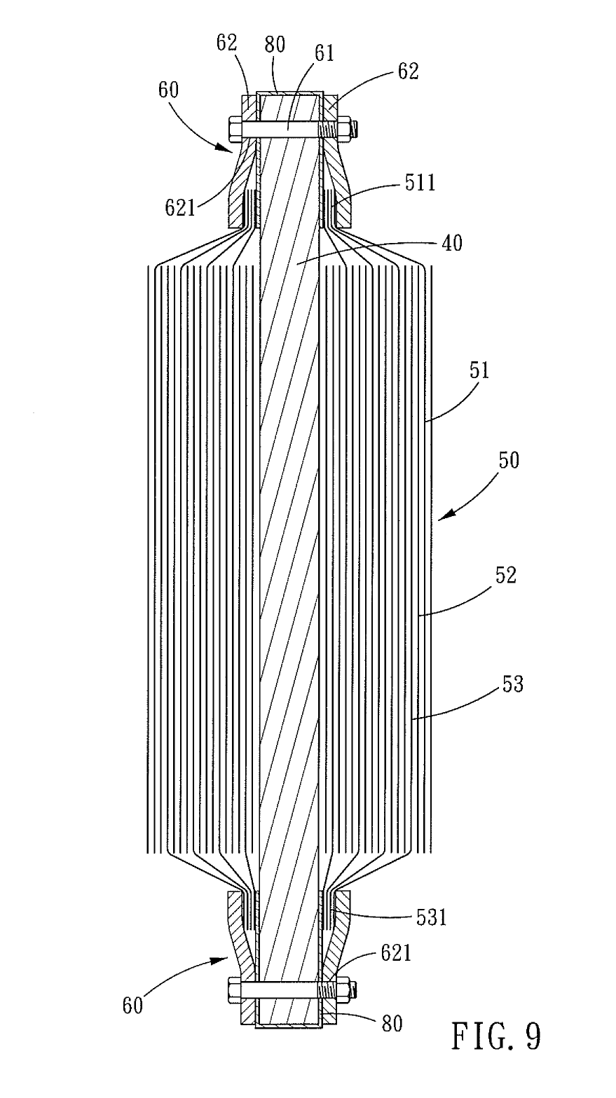

In addition, as shown in FIG. 9, either end of the base board 40 can be covered with a conductive sleeve 80, when the conductive pressing pieces 62 are pressed against the positive and negative lead areas 511, 531, the conductive sleeve 80 can improve the electrical connection between the pressing surfaces of the positive and negative lead areas 511, 531, thus increasing the current path in the charge and discharge process of the battery, and reducing the resistance of the battery.

While we have shown and described various embodiments in accordance with the present invention, it is clear to those skilled in the art that further embodiments may be made without departing from the scope of the present invention.

What is claimed is:

1. A core structure for a square lithium secondary battery being disposed in a battery case and electrically connected to positive and negative lead terminals of the battery case by two connecting members, the core structure comprising:
an isolating base board disposed in the battery case;
an electrode assembly including at least one positive layer, one separating layer and one negative layer, wherein the positive layer, the separating layer and the negative layer are superposed one another and then wind around the base board, an uncoated area is formed at a side of the positive layer for use as a positive lead area, and the negative layer is formed at another side thereof opposite the positive layer with an uncoated area for use as a negative lead area, the positive and negative lead areas protrude out of both sides of the electrode assembly;
two conductive fixing assemblies each including at least one fastener and one conductive pressing pieces, wherein the conductive pressing pieces are disposed outside the positive lead area or the negative lead area, the fastener is inserted through a through hole of one of the conductive pressing pieces is fixed on the base board, so that the conductive pressing piece is firmly pressed against the positive lead area or the negative lead area, and the positive lead area or the negative lead area is maintained in a close electrical contact with the conductive pressing piece, the conductive fixing assemblies are electrically connected to the positive lead terminal or the negative lead terminal by the connecting members.

2. The core structure for a square lithium secondary battery as claimed in claim 1, wherein either end of the base board is covered with a conductive sleeve, when the conductive pressing piece is pressed against the positive lead area or the negative lead area, the conductive sleeve can improve electrical connection between pressing surfaces of the positive lead area and negative lead area.

3. The core structure for a square lithium secondary battery as claimed in claim 1, wherein the conductive connecting members are a flexible wire.
